(19) United States
(12) Patent Application Publication
(10) Pub. No.: US 2024/0009980 A1
(43) Pub. Date: Jan. 11, 2024

(54) WOVEN CARPET TILES AND METHODS OF MAKING THE SAME

(71) Applicant: ALADDIN MANUFACTURING CORPORATION, Calhoun, GA (US)

(72) Inventors: Seth BREWER, Calhoun, GA (US); Michael BELL, Calhoun, GA (US); Billy M. JUMP, Calhoun, GA (US); Reginald FINLEY, Calhoun, GA (US); Emily GALISHOFF, Calhoun, GA (US)

(21) Appl. No.: 18/024,582

(22) PCT Filed: Sep. 2, 2021
(86) PCT No.: PCT/US2021/048882

§ 371 Date: Mar. 3, 2023

Related U.S. Application Data
(60) Provisional application No. 63/074,690, filed on Sep. 4, 2020.

(51) Int. Cl. B32B 27/12; B32B 5/02; B32B 27/32; B32B 27/20; B32B 7/12; B29C 48/00; B29C 48/07; B29C 48/154; B29C 48/21; B29C 48/88; B29C 33/56

(52) U.S. Cl. CPC B32B 27/12; B32B 5/024; B32B 5/022; B32B 27/32; B32B 27/20; B32B 7/12; B29C 48/0011; B29C 48/07; B29C 48/154; B29C 48/21; B29C 48/914; B29C 33/56; B32B 2471/04; B32B 2255/02; B32B 2255/26; B32B 2260/021; B32B 2260/046; B32B 2262/101; B32B 2262/0276; B32B 2262/12; B32B 2262/14; B32B 2307/718; B32B 2307/734; B32B 2307/744; B29K 2023/04; B29K 2233/04

(57) ABSTRACT

A carpet tile and process for making the same, wherein the carpet tile comprises a woven facecloth with an applied latex or hot-melt adhesive precoat, an extruded polymer backing layer, and an optional polyester cushion, comprising a reinforcing scrim layer within a polyester layer. The top surface and bottom surface of the carpet tile are defined by the facecloth and the polyester cushion or extruded layer, respectively. A polymer-based resin is extruded onto the pre-coat of the coated facecloth to form an at least substantially uniform backing layer, and the polyester cushion may be laid onto the extruded polymer backing layer while the extruded polymer backing layer remains above a softening temperature for the resin. The entire multi-layer web is then passed through a nip to embed the reinforcing scrim layer into the extruded polymer backing layer, and the entire web is chilled.

### CROSS-REFERENCE TO RELATED APPLICATIONS

The present application claims the benefit of and priority to U.S. Patent Application No. 63/074,690 filed on Sep. 4, 2020, the contents of which are hereby incorporated by reference in their entirety for all purposes.

### BACKGROUND

The installation techniques traditionally used to install modular carpet components such as carpet tiles puts a large emphasis on the need to ensure that each component is individually flat when installed. Whereas the edges of larger broadloom carpet installations may be positioned adjacent walls and/or may be specifically pinned to a subfloor, the edges of at least some smaller carpet tiles are generally exposed (possibly in the center of a room or high-traffic area) and may not be directly secured relative to their respective neighboring tiles. Thus, manufacturers of carpet tiles must ensure that these tiles do not curl (such that the carpet tile edges curl upward away from the subfloor) or dome (such that the middle of the carpet tile moves upward away from the subfloor) once installed. Each of these possible defects may create trip hazards for individuals walking along the tiled floor, or may create unsightly gaps between adjacent tiles. Even when each carpet tile is individually secured to the underlying subfloor (e.g., via an adhesive), internal forces within the carpet tile tending to curl or dome may cause portions of the tile to break away from the adhesive and the subfloor.

Further, carpet on top of a wet subfloor, particularly for an extended period of time, may be subject to a number of issues. One is that the carpet may develop mold or mildew. The presence of mildew in an area can cause respiratory issues for anyone who inhales mildew spores. Mold can cause even more severe health issues, such as long-term respiratory and cardiovascular issues, as well as causing structural damage. Mold and mildew may be more likely to develop in a carpeted area, compared to the same area without carpet, as moisture may become trapped under the carpet. Further, the presence of moisture may weaken adhesive that binds layers of carpet together, decreasing its usable life. Carpet in which the layers may move relative to one another can also pose a slip-and-fall danger. Moisture-related problems are particularly acute when carpet is on top of a concrete subfloor. In addition, carpet tiles may be prone to slipping on wet or dry subfloors.

Accordingly, a need exists for durable carpet tiles having desirable flatness characteristics and ability to prevent mold and mildew buildup, and other damage, due to moisture.

### BRIEF SUMMARY

Various embodiments are directed to a carpet tile comprising a woven fabric defining a top wear surface comprising a plurality of yarns. a woven fabric comprising a plurality of yarns, wherein the woven fabric defines an upper surface of the carpet tile;
a pre-coat layer adjacent to the woven fabric, said pre-coat layer comprising latex; and
an extruded polymer backing layer having a top surface bonded to the pre-coat layer and an opposite bottom surface.

Various embodiments are directed to a method of manufacturing a carpet tile, the method comprising providing a woven facecloth comprising a plurality of yarns; applying a pre-coat layer on one side of the woven fabric, said pre-coat layer comprising latex or a hot-melt adhesive; applying a polymer backing onto the pre-coat layer such that a top surface of the polymer backing is bonded to the pre-coat layer.

### BRIEF DESCRIPTION OF THE SEVERAL VIEWS OF THE DRAWINGS

Reference will now be made to the accompanying drawings, which are not necessarily drawn to scale, and wherein:

FIG. 1 is a side cutaway view showing various components of a carpet tile according to one embodiment.

FIG. 2A is a side view of an exemplary woven facecloth not having a “through-the-back” configuration.

FIG. 2B is a side view of an exemplary woven facecloth having a “through-the-back” configuration.

FIG. 3 is a cutaway view of the optional polyester cushion portion of the carpet tile.

FIGS. 4A and 4B are schematic diagrams of portions of a manufacturing line utilized to produce carpet tiles according to various embodiments.

FIG. 5 is a flowchart showing various steps involved in production of a carpet tile according to various embodiments.

### DETAILED DESCRIPTION

The present disclosure more fully describes various embodiments with reference to the accompanying drawings. It should be understood that some, but not all embodiments are shown and described herein. Indeed, the embodiments may take many different forms, and accordingly this disclosure should not be construed as limited to the embodiments set forth herein. Rather, these embodiments are provided so that this disclosure will satisfy applicable legal requirements. Like numbers refer to like elements throughout.

Various embodiments are directed to a carpet tile comprising a woven fabric comprising a plurality of yarns, wherein the woven fabric defines an upper surface of the carpet tile;
a pre-coat layer adjacent to the woven fabric, said pre-coat layer comprising latex; and
an extruded polymer backing layer having a top surface bonded to the pre-coat layer and an opposite bottom surface.

The carpet tile as described herein aims to solve at least one of the problems and/or disadvantages as described above. In particular, said carpet tile shows enhanced durability.

In certain embodiments, the carpet tile further comprises a polyester cushion bonded to the bottom surface of the polymer backing;
said polyester cushion comprising a reinforcing scrim layer embedded within a polyester layer.

In certain embodiments, the polyester cushion comprises a weight ratio of 3 to 30 oz per square yard (101.717 to 1017.172 gram per square meter), of which 0.25 to 2.5 oz per square yard (8.476 to 84.764 gram per square meter) is reinforcing scrim layer. In certain embodiments, the polyester cushion comprises a weight ratio of polyester to reinforcing scrim layer of 12:1 to 120:1.

In certain embodiments, the reinforcing scrim layer comprises a plurality of fibers, wherein the plurality of fibers comprise at least one of: glass fibers or polymer fibers. In certain embodiments, the plurality of fibers comprise polymer fibers comprises sheathed polyester core fibers. In certain embodiments, the reinforcing scrim layer comprises a plurality of nonwoven fibers. In certain embodiments, the reinforcing scrim layer comprises a nonwoven fiber mat. In certain embodiments, the nonwoven fiber mat comprises an air-laid grid. In certain embodiments, the reinforcing scrim layer comprises a woven fiber mat. In certain embodiments, the reinforcing scrim layer comprises a plurality of polymer fibers and a plurality of glass fibers.

In certain embodiments, the extruded polymer backing comprises a polyolefin. In certain embodiments, the extruded polymer backing may comprise, for example, in an amount between about 10-40 wt % of the weight of the extruded polymer backing. The extruded polymer backing may additionally comprise an inert filler material in an amount between about 20-80 wt % of the weight of the extruded polymer backing.

In certain embodiments, the weight of the carpet tile is between about 40-100 ounces per square yard (between about 1356.230 and 3390.575 gram per square meter). In certain embodiments, the weight of the carpet tile is between about 60-90 ounces per square yard (between about 2034.345 and 3051.517 gram per square meter).

In certain embodiments, the extruded polymer backing comprises a weight ratio of between about 15-45 ounces per square yard (between about 508.586 and 1525.759 gram per square meter), by preference of between about 15-40 ounces per square yard (between about 508.586 and 1356.230 gram per square meter), more by preference of between about 15-35 ounces per square yard (between about 508.586 and 1186.701 gram per square meter). In certain embodiments, the extruded polymer backing comprises a weight ratio of between about 15-30 ounces per square yard (between about 508.586 and 1017.172 gram per square meter).

In certain embodiments, the pre-coat layer has a viscosity of 1000 to 5000 cp at a temperature of 200-300° C. prior to application.

In certain embodiments, the pre-coat layer comprises latex or a hot-melt adhesive.

In certain embodiments, the woven fabric comprises yarns in a through-the-back configuration.

In certain embodiments, the yarns comprise one or more of nylon 6, nylon 6, 6, cotton, wool, nylon, acrylic, polyester, polyamides, polypropylene (PP), polyethylene terephthalate (PET), polytrimethylene terephthalate (PTT), and polyethylene naphthalate (PEN).

In certain embodiments, the plurality of yarns comprises warp yarns and weft yarns, and at least one of said warp yarns and said weft yarns are fibrillated.

In certain embodiments, the carpet tile is vinyl-free.

Various of the above-described embodiments aim to further improve durability of the carpet tile. Additionally and/or alternatively, various of the above-described embodiments aim to improve flatness characteristics of the carpet tile, wherein the tendency of said carpet tile to curl, dome and/or break away from the subfloor is reduced. Additionally and/or alternatively, various of the above described embodiments aim to prevent problems related to moisture, in particular, to prevent the buildup of mold and mildew, or to prevent other any other damage due to moisture.

Various embodiments are directed to a method of manufacturing a carpet tile, the method comprising providing a woven facecloth comprising a plurality of yarns; applying a pre-coat layer on one side of the woven fabric, said pre-coat layer comprising latex or a hot-melt adhesive; applying a polymer backing onto the pre-coat layer such that a top surface of the polymer backing is bonded to the pre-coat layer.

In certain embodiments, the method further provides pressing a polyester cushion against a bottom surface of the extruded polymer backing to bond the polyester cushion to the bottom surface of the extruded polymer backing such that the polyester cushion defines at least a portion of a bottom surface of the carpet tile, wherein said polyester cushion comprises a reinforcing scrim layer embedded within polyester

In certain embodiments, the method further comprises chilling the multi-layer construction comprising the coated facecloth, the extruded polyester, and optionally the polyester cushion. In certain embodiments, the method further comprises cutting the resultant carpet web into a plurality of carpet tiles. In certain embodiments, bonding the polyester cushion to the extruded polymer backing comprises compressing the multi-layer construction between nip rollers.

In certain embodiments, the polyester cushion comprises 3 to 30 oz of polyester per square yard (101.717 to 1017.172 gram of polyester per square meter), of which 0.25 to 2.5 oz of reinforcing scrim layer per square yard (8.476 to 84.764 gram of reinforcing scrim layer per square meter). In certain embodiments, the polyester cushion comprises a weight ratio of polyester to reinforcing scrim layer of 12:1 to 120:1.

In certain embodiments, extruding the polymer backing comprises extruding a polyolefin-based resin comprising between about 10-40 wt % polyolefin and between about wt % of a filler material, measured as portions of the weight of the resin.

In certain embodiments, the reinforcing scrim layer comprises a nonwoven fiber mat. In certain embodiments, the nonwoven fiber mat comprises an air-laid grid. In other embodiments, the reinforcing scrim layer comprises a woven fiber mat. In certain embodiments, the reinforcing scrim layer comprises at least one of: fiberglass fibers or polymer fibers.

In certain embodiments, said steps for extruding a polymer backing onto the first side of the facecloth and pressing a polyester cushion against the extruded polymer backing collectively form a backing construction having a weight between about 15-80 ounces per square yard (between about 508.586 and 2712.460 gram per square meter). In certain embodiments, said facecloth has a weight between about 10-50 ounces per square yard (between about 339.057 and 1695.287 gram per square meter), or 15-75 ounces per square yard (508.586 and 2542.931 gram per square meter) when precoated; and the multi-layer construction has a weight between about 38-85 ounces per square yard (between about 1288.418 and 2881.989 gram per square meter).

In certain embodiments, the extruded polymer backing comprises a weight ratio of between about 15-45 ounces per square yard (between about 508.586 and 1525.759 gram per square meter), by preference of between about 15-40 ounces per square yard (between about 508.586 and 1356.230 gram per square meter), more by preference of between about ounces per square yard (between about 508.586 and 1186.701 gram per square meter). In certain embodiments, the extruded polymer backing comprises a weight ratio of between about 15-30 ounces per square yard (between about 508.586 and 1017.172 gram per square meter).

In certain embodiments, the polymer backing is applied via extrusion or roll-coating.

In certain embodiments, the pre-coat layer has a viscosity of between 1000 and 5000 cp at a temperature of 200-300° C. In an embodiment, the viscosity is measured using a rotational viscometer or a rheometer.

In certain embodiments, the woven fabric comprises yarns in a through-the-back configuration.

In certain embodiments, the yarns comprise one or more of nylon 6, nylon 6, 6, cotton, wool, nylon, acrylic, polyester, polyamides, polypropylene (PP), polyethylene terephthalate (PET), polytrimethylene terephthalate (PTT), and polyethylene naphthalate (PEN).

In certain embodiments, the plurality of yarns comprises warp yarns and weft yarns, and at least one of said warp yarns and said weft yarns are fibrillated. In certain embodiments, the carpet tile is vinyl-free.

Carpet Tile

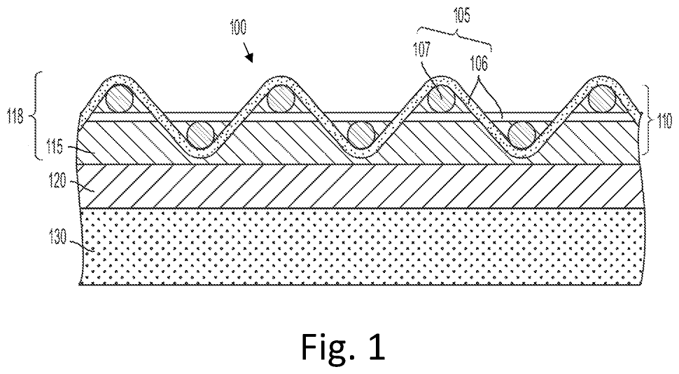

Referring to the figures, in which like numerals refer to like elements through the several figures, FIG. 1 is a cross sectional view (not to scale) of a carpet tile 100 in accordance with various embodiments of the present invention. In the illustrated embodiment, the carpet tile 100 includes woven facecloth 110, comprising yarns 105. In the pictured embodiment, the yarns 105 comprise warp (longitudinal) yarns 106 and weft (transverse) yarns 107. The yarns 105 may be made from various materials, both natural and synthetic, such as nylon 6, nylon 6, 6, cotton, wool, nylon, acrylic, polyester, polyamides, polypropylene (PP), polyethylene terephthalate (PET), polytrimethylene terephthalate (PTT), polyethylene naphthalate (PEN), and other polyolefins. The woven facecloth 110 may comprise two or more kinds of yarn 105. For example, the warp yarns 106 may be different than the weft 107 yarns. In an embodiment, the warp yarns 106 comprise nylon yarns, and the weft yarns 107 comprise fibrillated polypropylene yarns. The face weight of the yarn 105 can be approximately 5 ounces per square yard to approximately 50 ounces per square yard (approximately 169.529 gram per square meter to approximately 1695.287 gram per square meter).

In an embodiment, some or all of the yarns 105 have a denier of 0.5-50 per filament, wherein the denier of a yarn is understood to refer to its weight in grams per 9000 meters of length. In an embodiment, some or all of the yarns 105 independently have a denier of at least, at most, or about 0.5, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 per filament. In an embodiment, some or all of the yarns 105 independently have a denier of about 800-3600. In an embodiment, some or all of the yarns 105 independently have a denier of about 1250-1750. In an embodiment, some or all of the yarns 105 independently have a denier of at least, at most, or about 800, 900, 1000, 1100, 1200, 1300, 1400, 1500, 1600, 1700, 1800, 1900, 2000, 2100, 2200, 2300, 2400, 2500, 2600, 2700, 2800, 2900, 3000, 3100, 3200, 3300, 3400, 3500, or 3600.

Each of the yarns may independently be single-ply (containing one strand of fiber) or multi-ply (containing more than one strand of fiber), such as 2-ply, 3-ply, etc. In embodiments, each of said yarns has a ply selected from the group consisting of 1-, 2-, 3-, 4-, 5-, 6-, 7-, 8-, 9-, and 10-ply.

In an embodiment, at least one of the warp yarns 106 and weft yarns 107 comprise fibrillated yarns.

In a preferred embodiment, the weft yarns 107 will comprise fibrillated polyolefin yarns. In an embodiment, the polyolefin is selected from the group consisting of PET, PP, PEN, and PTT.

In an embodiment, the plurality of yarns comprises warp yarns and weft yarns, and at least one of said warp yarns and said weft yarns are fibrillated.

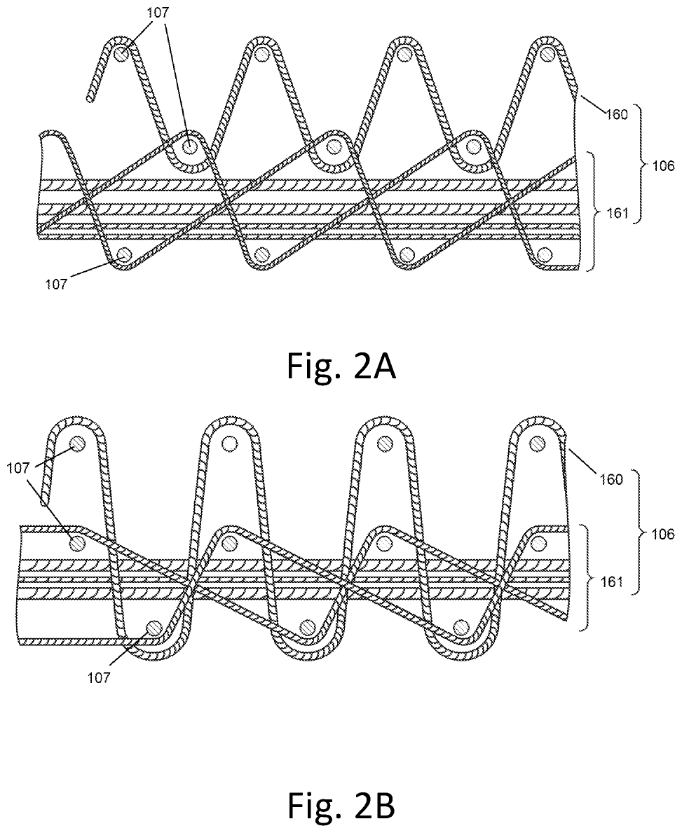

The configuration of the yarns 105 relative to each other in the woven facecloth 110 may vary. This is exemplified by the different configurations shown in FIGS. 2A and 2B, both of which show the relative configurations of warp yarns 106 and weft yarns 107 in two different woven facecloths, from the side. The top of each figure corresponds to the top of the carpet tile when assembled. As shown in each of FIGS. 2A and 2B, the warp yarns 106 include a face yarn 160, which will be the predominant yarn on the surface of the carpet when assembled, in addition to other warp yarns 161.

In FIG. 2A, the face yarn 160 does not go through to the opposite, bottom side of the woven facecloth. In the preferred embodiment shown in FIG. 2B, however, the face yarn 160 does go completely through to the bottom side, in a “through-the-back” (TTB) configuration. When a pre-coat layer is applied to the bottom side of the woven facecloth shown in FIG. 2B, as discussed in more detail below, it is able to lock in the face yarn 160, making the carpet tile more resistant to unraveling and fraying.

The woven facecloth 110 will form an upper surface of the carpet tile 100. A pre-coat layer 115 is applied to a first side of the facecloth 110, so as to form a coated facecloth 118. The pre-coat layer 115 penetrates the yarn 105 and encapsulates individual yarns to at least partially bind strands of yarn 105 to each other. This may provide structural integrity to the facecloth 110 and carpet tile 100 during the manufacturing process. The pre-coat layer 115 may also act as a tackifier to provide an acceptable binding surface for a subsequent polymer layer.

In an exemplary embodiment, the pre-coat layer 115 comprises an aqueous-latex based polymer configured to support the yarn 105 within the facecloth 110 upon drying or curing. In certain embodiments, the pre-coat layer 115 comprises latex based compounds, such as styrene butadiene copolymer latex (SBR latex). The pre-coat layer 115 may include one or more other components or topicals, such as inert filler materials (e.g., fly ash) or flame retardants as discussed in reference to the extruded polymer backing layer 120 herein, in an amount of 0.1-1,000 parts by weight, relative to the weight of the latex being 100 parts. In an alternate embodiment, the pre-coat layer comprises a hot-melt adhesive (HMA) which contains a tackifying resin or agent alone or in combination with polyethylene

The pre-coat layer 115 may be applied to a bottom surface of the facecloth 110 in the range of approximately 2 ounces per square yard to approximately 20 ounces per square yard (approximately 67.811 gram per square meter to approximately 678.115 gram per square meter), and more preferably in the range of approximately 8 ounces per square yard to approximately 12 ounces per square yard (approximately 271.246 gram per square meter to approximately 406.869 gram per square meter).

In an embodiment, one or more topicals (flame retardant, soil resist, etc.) are applied to the top of the carpet following drying/curing of the pre-coat layer 115. In an embodiment, the one or more topicals are applied as a foam. In an embodiment, the one or more topicals are applied using a squeeze roller.

Disposed on a bottom surface of the coated facecloth 118 is a backing construction comprising an extruded polymer backing layer 120 and, optionally, a polyester cushion 130. The backing construction is arranged such that the extruded polymer backing layer 120 is positioned between the polyester cushion 130 and the coated facecloth 118. In such an embodiment, a first (top) side of the extruded polymer backing layer 120 is bonded to the coated facecloth 118, and a second (bottom) side of the extruded polymer backing layer 120 is bonded to the polyester cushion 130. The extruded polymer backing layer 120 is embodied as a resin comprising one or more components collectively configured to give the resulting carpet tile 100 a flat overall appearance without substantial doming (a central portion of the carpet tile 100 rising relative to the edges such that a top surface of the carpet tile 100 is convex) or curling (the edges of the carpet tile 100 rising relative to the central portion such that a top surface of the carpet tile 100 is concave). The resin of the extruded polymer backing layer 120 may comprise a polyolefin, a thermoplastic polymer, a mixture of two or more polyolefins, or a mixture of one or more polyolefins together with one or more other polymers. For example, the resin may comprise polyvinyl chloride, polyethylene, and/or polypropylene. As specific examples, a polyolefin polymer is embodied as 1-propene, ethylene copolymer or ethylene-propylene copolymer. In certain embodiments, the resin of the extruded polymer backing layer 120 comprises the polymer mixture in an amount between about 10-40 wt % of the resin of the extruded polymer backing layer 120 (and of the extruded polymer backing layer 120 itself). In an embodiment, the carpet tile comprises only one extruded polymer backing layer.

The resin of the extruded polymer backing layer 120 may additionally comprise one or more additives, such as an inert filler material, a colorant, an antioxidant, a tackifier, a viscosity modifier, a flame retardant, and/or the like.

The inert filler material may constitute the majority of the resin of the extruded polymer backing layer 120 (by weight), and may function as a low cost material that adds weight to the extruded polymer backing layer 120 to aid in forming an at least substantially flat carpet tile 100. For example, the inert filler material may constitute between about 20-wt % of the resin and/or the extruded polymer backing layer 120.

The inert filler material may be made from carbonates such as calcium carbonate (CaCO₃), cesium carbonate (CsCO₃), strontium carbonate (SrCO₃), and magnesium carbonate (MgCO₃); sulfates such as barium sulfate (BaSO₃); oxides such as iron oxide (Fe₂O₃ or Fe₃O₄), aluminum oxide (Al₂O₃), tungsten oxide (WO₃), titanium oxide (TiO₂), silicon oxide (SiO₂); silicates, such as clay; metal salts; fly ash and the like.

Additionally, the inert filler material may be made from post-consumer products, such as post-consumer glass, post-consumer carpets and/or other post-consumer recycled materials. In cases where the inert filler is made from post-consumer glass, the post-consumer glass is ground into a fine glass powder before it is added as filler. The glass cullet may be made from automotive and architectural glass, also known as plate glass, flint glass, E glass, borosilicate glass, brown glass (bottle glass), green glass (bottle glass), or coal fly ash, or a combination thereof. In the case where post-consumer carpet is used as the inert filler material, the post-consumer carpet maybe ground into a fine cullet and added to the hot melt adhesive. In addition to the post-consumer carpet, remnants and trimmings of carpet (e.g., comprising trim waste from cutting carpet tiles from rolls of carpet, sometimes referred to as window waste), fine waste fibers that are a result of the shearing process, and the like, that are produced as a by-product during the manufacturing process may also be used to form the inert filler material.

The filled or unfilled polymer may also contain a colorant, such as carbon black or another colorant(s) to provide color and increase the opaqueness of the extruded polymer backing layer 120. Typically, the colorant may be present in an amount less than or equal to approximately 1 wt % the filled or unfilled resin and extruded polymer backing layer 120. For example, the colorant may be present in an amount between about 0.1-0.5 wt % of the extruded polymer backing layer 120. As a specific example, the colorant may be present in an amount of approximately 0.1 wt % of the resin and the extruded polymer backing layer 120.

Moreover, to reduce the possibility of thermo-oxidation degradation, the polymer may also contain one or more antioxidants. Some suitable antioxidants include, but are not limited to amines, 2,2′-methylene bis-(4-methyl-6-tert-butylphenol), 2,4,6-tri-tert-butylphenol, 2,6-di-tert-butyl-4-methylphenol, 4,4′-thio-bis-(6-tert-butyl-m-cresol), butylated hydroxy anisole, butylated hydroxy toluene, bis(hydrogenated tallow alkyl),oxide; tris(2,4-ditert-butylphenyl)phosphite and 1,3,5 triazine-2,4,6(1H, 3H, 5H)-trione,1,3,5,tris-((3,5-(1-dimethylethyl))-4-hydroxyphenyl)methyl. Typically, the antioxidant may be present in the filled or unfilled extruded polymer backing layer 120 in an amount less than or equal to approximately 2 wt % of the resin and/or the extruded polymer backing layer 120, such as between about 0.05-0.5 wt % of the resin and/or the extruded polymer backing layer 120.

Moreover, the extruded polymer backing layer 120 may additionally include one or more tackifiers to aid in forming a strong mechanical bond with the coated facecloth 118, and/or the polyester cushion 130 discussed in further detail below.

The resin of the extruded polymer backing layer 120 may additionally include one or more viscosity modifiers and/or compatibilizers, such as, for example, olefins of higher or lower molecular weight than the resin discussed herein or ethylene maleic anhydride copolymer, to ensure proper flow and bonding of the resin within filler and polymers when applying onto the coated facecloth 118. The viscosity modifier may be present in an amount between about 0.1-3 wt % of the resin and the extruded polymer backing layer 120.

In certain embodiments, the resin of the extruded polymer backing layer 120 may additionally comprise one or more flame retardants, such as, but not limited to, aluminum trihydrate (ATH) or magnesium hydroxide (MgOH) for applications where flame-retardancy is desired. One or more flame retardants may be necessary to comply with applicable regulations regarding the installation and/or usage of carpet tiles in certain applications, for example, when such carpet tiles are installed in transportation vehicles (e.g., buses, aircraft, and the like).

Referring again to FIG. 1, the carpet tile 100 additionally may comprise a polyester cushion 130 pressed against the extruded polymer layer 120 to define, at least in part, the bottom surface of the carpet tile 100. The polyester cushion 130 imparts dimensional stability to the finished carpet tile 100. Because the polyester cushion 130 is positioned on the bottom surface of the carpet tile 100, the polyester cushion 130 provides additional support against curling and/or doming of the carpet tile.

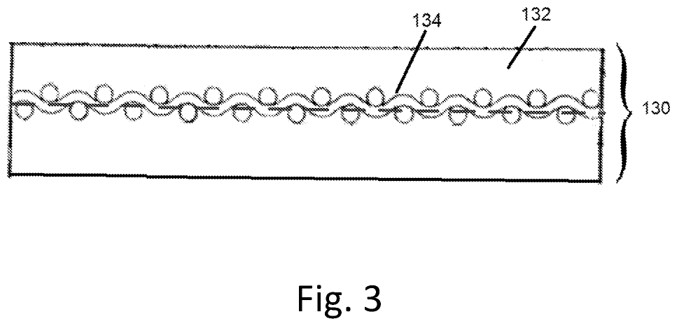

The polyester cushion 130 comprises a polyester layer 132 with an integrated reinforcing scrim layer 134, as seen in FIG. 3. In an alternative embodiment (not pictured), the polyester cushion 130 does not comprise a reinforcing scrim layer, and consists solely of a polyester layer 132.

The polyester layer 132 may comprise any suitable polyester. Such polyesters include, but are not limited to, PET, PTT, PBT, PEN, poly(ethylene terephthalate-co-isophthalate) and copolymers thereof. In a preferred embodiment, the polyester is PET. The polyester layer 132 may be woven or nonwoven. In a preferred embodiment, the polyester layer 132 is nonwoven.

The reinforcing scrim layer 134 may comprise a fibrous material provided in either a woven or non-woven configuration. When provided on the bottom surface of the carpet tile 100, a polyester cushion 130 provides desirable protection against mold and mildew formation when the carpet tile 100 is on a wet subfloor. In an embodiment, the reinforcing scrim layer 134 is in the middle of the polyester cushion 130, such that approximately half of the polyester layer 132 is on one side of the reinforcing scrim layer 134, and approximately half of the polyester layer 132 is on the other side of the reinforcing scrim layer 134. In other embodiments, about 0.1-99.9% of the polyester layer 132 is on one side of the reinforcing scrim layer 134, and about 99.9-0.1% of the polyester layer 132 is on the other side of the reinforcing scrim layer 134. In an embodiment, so little of the polyester layer 132 is on the top side of the reinforcing scrim layer 134 that the reinforcing scrim layer 134 is in contact with the extruded polymer layer 120. In an embodiment, a first side of the reinforcing scrim layer 134 is in contact with the extruded polymer layer 120, and a second side of the reinforcing scrim layer 134 is in contact with the polyester layer 132. In this embodiment, the polyester layer 132 may be in contact with the extruded polymer layer 120 due to the openness of the reinforcing scrim layer 134.

The reinforcing scrim layer 134 may contain fibrous materials, which themselves may constitute any number of natural or synthetic materials. The fibrous material may additionally and/or alternatively comprise one or more polymer based fibers, such as polyester fibers, polyamide fibers, polyurethane fibers, combinations thereof, and/or the like. For example, the polymer fibers may comprise polypropylene fibers, polyethylene fibers, sheathed polymer fibers (e.g., having a polyethylene core and a nylon or polypropylene sheath), and/or the like. As yet another example, the fibrous material may comprise a composite of polymer-based fibers and other fibers (e.g., glass fibers). Such a composite may comprise layers of non-woven and/or woven layers (e.g., a first layer comprising a polymer-based fiber material and a second layer comprising a glass fiber material).

Method of Manufacture

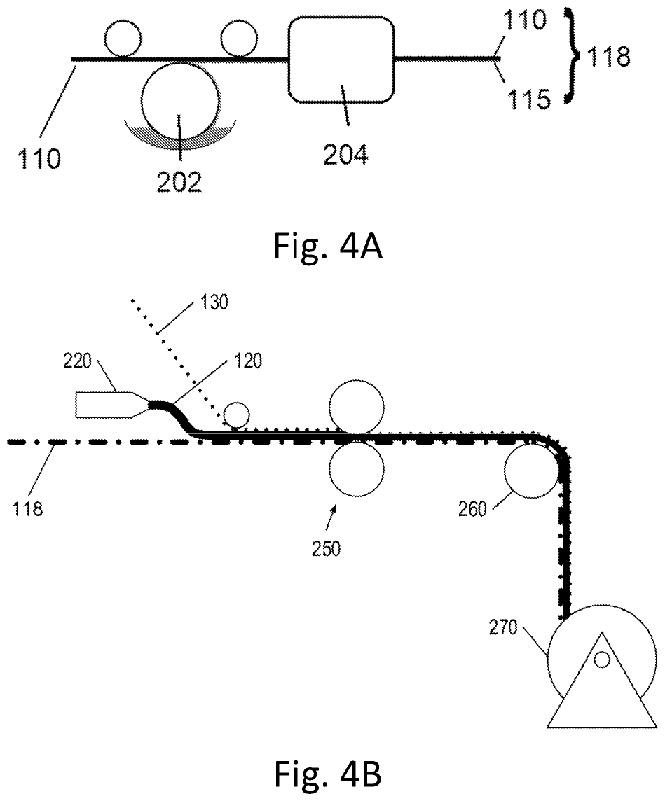

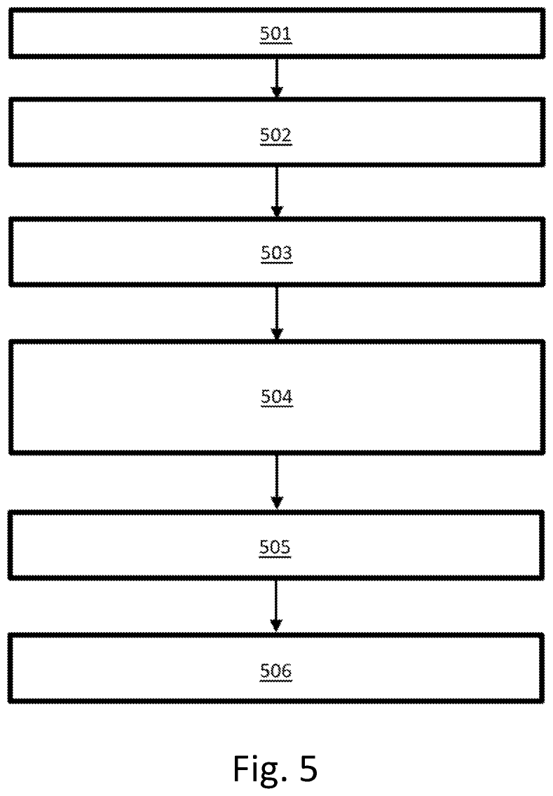

FIGS. 4A and 4B are schematic diagrams of portions of a non-limiting example of a carpet tile manufacturing line that may be utilized to construct a carpet tile 100 as discussed herein, and FIG. 5 is a flow chart of an example method for constructing the carpet tile 100 according to certain embodiments. As discussed herein, the carpet tiles 100 may be manufactured as a portion of a continuous web and later cut into desired tile shapes and sizes. However, it should be understood that carpet tiles 100 may be manufactured according to any of a variety of manufacturing processes, such as a batch process in which each multi-layer carpet tile 100 is constructed as a separate component.

As discussed herein, the topside of the woven facecloth 110 ultimately forms the top surface of the completed carpet tile 100. As mentioned, the facecloth 110 is provided as a continuous web, which may be threaded along a web travel path defined by a plurality of rollers (e.g., powered rollers and/or idler rollers). In certain embodiments, the facecloth 110 may have a width between 72-80 inches (between 182.88 and 203.20 centimeters), although it should be understood that the facecloth 110 may have any width with suitable production equipment, such as up to 90, 100, 110, 120, 130, 140, 150, 160, 170, 180, 190, and 200 inches (such as up to 228.60, 254.00, 279.40, 304.80, 330.20, 355.60, 381.00, 406.40, 431.80, 457.20, 482.60 and 508.00 centimeters).

As shown in FIG. 4A, the process begins by providing the woven facecloth 110 (as indicated at Block 501 of FIG. 5). A latex pre-coat layer 115 is disposed on a backside of the facecloth 110 by an applicator 202, so as to form a coated facecloth 118. In various embodiments, the applicator 202 is a roll-coater, such as a kiss coater, or an extruder. The applicator depicted in FIG. 4A is a kiss coater. In an embodiment, following formation of the coated facecloth 118, the coated facecloth may be sent through an oven 204 for drying and/or curing.

An advantage of the roll-coating application is that the pre-coat layer 115 may be applied using a low-viscosity composition at the application temperature, without the need for frothing, as in some puddle-coating applications. A low-viscosity pre-coat has the additional advantage of being able to better penetrate the fibers of the yarns 105, along with the open space within the woven facecloth 110, so as to better bind the yarns. In certain embodiments, the pre-coat layer has a viscosity of between 1000 and 5000 cp as measured at a temperature of 200-300° C. In certain embodiments, the pre-coat layer has a viscosity of no greater than, no more than, or about 1000 cp, 1100, 1200 cp, 1300 cp, 1400 cp, 1500 cp, 1600 cp, 1700 cp, 1800 cp, 1900 cp, 2000 cp, 2100, 2200 cp, 2300 cp, 2400 cp, 2500 cp, 2600 cp, 2700 cp, 2800 cp, 2900 cp, 3000 cp, 3100, 3200 cp, 3300 cp, 3400 cp, 3500 cp, 3600 cp, 3700 cp, 3800 cp, 3900 cp, 4000 cp, 4100, 4200 cp, 4300 cp, 4400 cp, 4500 cp, 4600 cp, 4700 cp, 4800 cp, 4900 cp, or 5000 cp.

Following drying/curing, the coated facecloth 118 may have topicals (such as flame retardants, soil resist, etc.) applied using any method known in the art. In some embodiments, following application of topicals, the coated facecloth will again be dried/cured in another oven.

In the next step of the manufacturing process, the coated facecloth 118 is then advanced along the web travel path in an inverted orientation with the backside of the coated facecloth 118 facing upward, as indicated at Block 502 of FIG. 5. The coated facecloth 118 is advanced past one or more extruder heads 220 configured to extrude a continuous sheet of a resin having an at least substantially uniform thickness onto the backside of the coated facecloth 118 to form the extruded polymer backing layer 120, as indicated at Block 503. In certain embodiments, the extruder head 220 may comprise a single, elongated extrusion die tip opening extending across the entire width of the coated facecloth 118 such that the resin is extruded as a continuous sheet from the extruder head 220. Alternatively, the resin may be extruded from a plurality of extruder heads 220 positioned across the width of the web travel path. The plurality of extruder heads may be spaced such that the resin flows together to form an at least substantially continuous extruded polymer backing layer 120 having an at least substantially uniform thickness across the width of the coated facecloth 118.

The one or more extruder heads 220 may be supplied by one or more extruders (e.g., single screw extruders and/or dual-screw extruders) configured to combine the various components of the resin prior to extrusion to form the extruded polymer backing layer 120. Once combined, the extruders and one or more extruder heads 220 provide the at least substantially continuous sheet of resin onto the bottom surface of the coated facecloth 118 at a temperature between about 275-500 degrees Fahrenheit (between about 135.0 and 260.0 degrees Celsius) and at a weight of between about 8-35 ounces per square yard (between about 271.246 and 1186.701 gram per square meter). The resin may be applied to the coated facecloth 118 while the pre-coat layer 115 is sufficiently hot (as may be the case with a hot melt adhesive) so as to retain a tacky characteristic (e.g., while the pre-coat layer material remains above its softening point) to improve the mechanical bond strength between the coated facecloth 118 and the extruded polymer backing layer 120.

After extruding the resin of the extruded polymer backing layer 120 onto the facecloth 110, the polyester cushion 130 is laid onto the exposed bottom surface of the extruded polymer backing layer 120 as indicated at Block 504 of FIG. 5, in embodiments in which the polyester cushion 130 is present. The extruded polymer backing layer 120 remains above the resin softening point when the polyester cushion 130 is laid onto the exposed surface of the extruded polymer backing layer 120, and the entire multi-layer web (including the facecloth 110, the pre-coat layer 115, the extruded polymer backing layer 120, and the polyester cushion 130) is passed through a nip 250 comprising two rollers positioned on opposite sides of the web travel path to compress the multi-layer web and to provide strong bonds between adjacent layers of the carpet tile 100. During compression, the extruded polymer backing layer 120 is bonded to the facecloth 110, and the polyester cushion 130 is bonded to the extruded polymer backing layer 120 (as indicated at Block 505). The polyester cushion 130, when present, defines at least a portion of the bottom surface of the resulting carpet tile 100.

After the moving multi-layer web passes through the nip 250, the web passes through one or more chilling rollers 260 to cool and harden the extruded polymer backing layer 120 (shown at Block 506). For example, the one or more chilling rollers 260 may be collectively configured to chill the extruded polymer backing layer 120 to approximately room temperature (between about 75-80 degrees Fahrenheit, i.e. between about 23.9 and 26.7 degrees Celsius).

In particular, FIG. 5 shows a flow chart of an example method for constructing the carpet tile 100 according to certain embodiments, comprising the following steps: providing a woven facecloth (block 501), applying a latex pre-coat to a bottom side of the woven cloth (block 502), extruding a continuous sheet of polymer backing material onto the pre-coat side of the woven facecloth (block 503), optionally layering a polyester cushion onto an exposed surface of the extruded polymer backing while the extruded polymer backing remains above a softening temperature to form a multi-layer web (block 504), advancing the multi-layer web through a nip to bind the layers (block 505), and advancing the multi-layer web through one or more chilling rollers to cool the multi-layered web (block 506).

In a non-pictured embodiment, the nip rollers may also serve as the chilling rollers.

The cooled multi-layer construction may then be passed to a tile cutting mechanism configured to cut the multi-layer web into a plurality of individual carpet tiles or to a take-up roller 270 for storage. For example the web may be passed into a die cutter to cut the material web into market-size carpet tiles 100 (e.g., 18″×18″, 24″×24″, or 36″×36″, i.e. 45.72 cm×45.72 cm, 60.96 cm×26.96 cm, or 91.44 cm×91.44 cm). Alternatively, the material web may be taken onto a large diameter (e.g., 8-foot diameter, i.e. 243.84 centimeter diameter) drum where it can be taken to an off-line die cutting station for further processing into carpet tiles 100.

Example and Discussion

An example carpet tile is manufactured according to the methodology discussed herein. The example carpet tile comprises a facecloth 110 having a weight of at least about ounces per square yard (at least about 339.057 gram per square meter). In an embodiment, the facecloth has a weight of about 10-80 ounces per square yard (about 339.057 to 2712.460 gram per square meter). The facecloth 110 is roll-coated with a pre-coat layer 115 having a weight of at least approximately 5 ounces per square yard, so as to form a coated facecloth 118. In an embodiment, the pre-coat layer 115 is present in an amount of at least, at most, or about 5, 6, 7, 8, 9, 10, 11, 12, 13, 14, 15, 16, 17, 18, 19, 20, 21, 22, 23, 24, or 25 ounces per square yard (at least, at most, or about 169.529, 203.434, 237.340, 271.246, 305.152, 339.057, 372.963, 406.869, 440.775, 474.680, 508.586, 542.492, 576.398, 610.303, 644.209, 678.115, 712.021, 745.926, 779.832, 813.738, or 847.644 gram per square meter).

The coated facecloth 118, now pre-coated, is passed under an extruder head 220 as a part of a continuous web, where the resin of the extruded polymer backing layer 120 is extruded onto the exposed surface of the pre-coat layer 115, to form the extruded polymer backing layer 120. In this example, the extruded polymer backing layer 120 comprises a polyolefin resin mixture heated to a temperature of 325-475 degrees Fahrenheit (163-246 degrees Celsius) for extrusion.

The resin is extruded in a continuous sheet onto the pre-coat layer 115 to create an at least substantially uniform extruded polymer backing layer 120 having an at least substantially uniform thickness.

Before the extruded polymer backing layer 120 cools to a temperature below the softening point of the resin, a polyester cushion 130 comprising a reinforcing scrim layer embedded within polyester is laid onto the exposed surface of the extruded polymer backing layer 120, and the entire multi-layer web is passed through a nip 250 and through one or more chilling rollers 260 to press the polyester cushion 130 against the extruded polymer backing layer 120 and to cool and harden the extruded polymer backing layer 120. The cooled web is then cut into individual carpet tiles 100 for evaluation.

The carpet tile 100 provided according to this example construction exhibits superior ability to resist or prevent mold or mildew growth when placed on a wet subfloor, with desirable durability and a relatively low weight.

Tiles prepared according to the described embodiments will, overall, exhibit good slip resistance and durability based on the polymer which forms the bottom of the tile, in conjunction with the soft surface and acoustical benefits of the softer, woven facecloth forming the top surface of the tile.

Moreover, carpet tile prepared using woven face fabric, as discussed herein, will have an additional advantage over similar carpet tile prepared using tufted face fabric. Specifically, tufted fabric can suffer from what is known as a “grinning” defect when cut to a low pile height, meaning that the primary backing of the tufted fabric can be seen between the piles. The flat profile of a woven fabric will be able to support lower pile heights without exhibiting the grinning defect.

### CONCLUSION

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1.-43. (canceled)

44. A carpet tile comprising:
a woven fabric comprising a plurality of yarns, wherein the woven fabric defines an upper surface of the carpet tile;
a pre-coat layer adjacent to the woven fabric, said pre-coat layer comprising latex;
an extruded polymer backing layer having a top surface bonded to the pre-coat layer and an opposite bottom surface;
a polyester cushion bonded to the bottom surface of the polymer backing, wherein said polyester cushion comprising a reinforcing scrim layer embedded within a polyester layer; and
wherein the woven fabric comprises yarns in a through-the-back configuration.

45. The carpet tile of claim 44, wherein the polyester cushion comprises a weight ratio of polyester to reinforcing scrim layer of 12:1 to 120:1.

46. The carpet tile of claim 44, wherein the reinforcing scrim layer comprises a plurality of fibers and wherein the plurality of fibers comprise at least one of glass fibers and polymer fibers; and wherein the plurality of fibers comprise sheathed polyester core fibers.

47. The carpet tile of claim 46, wherein the reinforcing scrim layer comprises a nonwoven fiber mat comprising an air-laid grid.

48. The carpet tile of claim 46, wherein the reinforcing scrim layer comprises a woven fiber mat.

49. The carpet tile of claim 46, wherein the reinforcing scrim layer comprises a plurality of polymer fibers and a plurality of glass fibers.

50. The carpet tile of claim 49, wherein the extruded polymer backing comprises a polyolefin; wherein the extruded polymer backing comprises between about 10-40 wt % polyolefin.

51. The carpet tile of claim 44, wherein the extruded polymer backing comprises between about 20-80 wt % of a filler material.

52. The carpet tile of claim 51, wherein the weight of the carpet tile is between about ounces per square yard (between about 847.644 and 5085.862 gram per square meter).

53. The carpet tile of claim 52, wherein the weight of the carpet tile is between about ounces per square yard (between about 1356.230 and 2712.460 gram per square meter).

54. The carpet tile of claim 53, wherein the extruded polymer backing has a weight of between about 15-30 ounces per square yard (between about 508.586 and 1017.172 gram per square meter).

55. The carpet tile of claim 54, wherein the pre-coat layer has a viscosity of between 1000 and 5000 at a temperature of 200-300° C. prior to application.

56. The carpet tile of claim 55, wherein the pre-coat layer comprises latex or a hot-melt adhesive.

57. A method of manufacturing a carpet tile, the method comprising:
providing a woven fabric comprising a plurality of yarns and wherein the woven fabric comprises yarns in a through-the-back configuration;
applying a pre-coat layer on one side of the woven fabric, said pre-coat layer comprising latex or a hot-melt adhesive;
wherein the pre-coat layer has a viscosity of 1000 to 5000 cp at a temperature of 200-300° C.;
applying a polymer backing onto the pre-coat layer such that a top surface of the polymer backing is bonded to the pre-coat layer; and
pressing a polyester cushion against a bottom surface of the polymer backing to bond the polyester cushion to the bottom surface of the polymer backing such that the polyester cushion defines at least a portion of a bottom surface of the carpet tile;
wherein said polyester cushion comprises a reinforcing scrim layer embedded within polyester.

58. The method of claim 57, wherein bonding the polyester cushion to the polymer backing comprises compressing the multi-layer construction between nip rollers, optionally wherein the nip rollers also serve as chilling rollers.

59. The method of claim 58, wherein the step of applying the polymer backing onto the pre-coat layer comprises the step of extruding a resin onto the facecloth to form an extruded polymer backing layer;
wherein after extruding the resin of the extruded polymer backing layer onto the facecloth, the polyester cushion is laid onto the exposed bottom surface of the extruded polymer backing layer;
wherein the extruded polymer backing layer remains above the resin softening point when the polyester cushion is laid onto the exposed surface of the extruded polymer backing layer.

60. The method of claim 59, wherein the method comprising the step of passing the entire multi-layer web—comprising the facecloth, the pre-coat layer, the extruded polymer backing layer, and the polyester cushion—through a nip comprising two rollers positioned on opposite sides of the web travel path to compress the multi-layer web and to provide strong bonds between adjacent layers of the carpet tile.

61. The method of claim 60, further comprising chilling the multi-layer construction.

62. The method of claim 61, wherein the polymer backing is applied via extrusion or roll-coating.

63. The method of claim 62, wherein applying the polymer backing comprises applying a polyolefin-based resin, wherein the polyolefin-based resin comprises between about 10-40 wt % polyolefin and between about 20-80 wt % of a filler material.
